(19) United States
(12) Patent Application Publication
(10) Pub. No.: US 2020/0159136 A1
(43) Pub. Date: May 21, 2020

(54) ELECTROPHOTOGRAPHIC PHOTOSENSITIVE MEMBER, PRODUCTION METHOD THEREFOR, PROCESS CARTRIDGE, AND ELECTROPHOTOGRAPHIC IMAGE-FORMING APPARATUS

(71) Applicant: CANON KABUSHIKI KAISHA, Tokyo (JP)

(72) Inventors: Haruki Mori, Ichikawa-shi (JP); Masaki Nonaka, Toride-shi (JP); Eileen Takeuchi, Tokyo (JP)

(21) Appl. No.: 16/673,485

(22) Filed: Nov. 4, 2019

(30) Foreign Application Priority Data
Nov. 16, 2018 (JP) 2018-215814

(51) Int. Cl. G03G 5/07; G03G 5/05; G03G 15/08

(52) U.S. Cl. CPC G03G 5/07; G03G 15/0868; G03G 5/05

(57) ABSTRACT

Provided is an electrophotographic photosensitive member that can achieve both of satisfactory wear resistance and the suppression of an image streak at the time of its repeated use. The electrophotographic photosensitive member includes a support and a photosensitive layer. The surface layer of the electrophotographic photosensitive member contains: a polymer of a hole-transportable compound having a chain-polymerizable functional group; and an ester compound having specific alkyl groups.

### BACKGROUND OF THE INVENTION

### Field of the Invention

The present disclosure relates to an electrophotographic photosensitive member and a production method for the electrophotographic photosensitive member, and a process cartridge and an electrophotographic image-forming apparatus each including the electrophotographic photosensitive member.

### Description of the Related Art

As an electrophotographic photosensitive member to be mounted onto an electrophotographic image-forming apparatus (hereinafter sometimes referred to as “electrophotographic apparatus”), there is used an organic electrophotographic photosensitive member (hereinafter referred to as “electrophotographic photosensitive member”) containing an organic photoconductive substance (charge-generating substance), and a wide variety of investigations have heretofore been made on the electrophotographic photosensitive member.

For example, a reduction in image quality along with a reduction in thickness of the electrophotographic photosensitive member at the time of its repeated use is one problem in the electrophotographic photosensitive member, and various investigations have been made on the problem. In Japanese Patent Application Laid-Open No. 2002-268250, there is a description of an electrophotographic photosensitive member in which an additive is incorporated into a photosensitive layer, and high stability of image quality is expressed even when the thickness of the photosensitive layer reduces along with the repeated use of the photosensitive member.

In addition, in recent years, along with an increase in printing speed, the lengthening of the lifetime of the electrophotographic photosensitive member has been required, and hence many attempts have been made to suppress the reduction in thickness at the time of the repeated use. In Japanese Patent Application Laid-Open No. 2000-66425, there is a description of an electrophotographic photosensitive member containing, in its surface layer, a cured product of a hole-transportable compound having a chain-polymerizable functional group, and the photosensitive member expresses excellent mechanical durability (wear resistance). The abrasion resistance of the surface layer is improved probably because the cured product has a three-dimensional crosslinked structure.

### SUMMARY OF THE INVENTION

The above-mentioned objects are achieved by the following present disclosure. That is, according to one aspect of the present disclosure, there is provided an electrophotographic photosensitive member including: a support; and a photosensitive layer, wherein a surface layer of the electrophotographic photosensitive member contains: a polymer of a hole-transportable compound having a chain-polymerizable functional group; and a compound represented by the following formula (1):

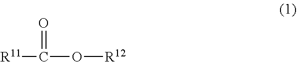

in the formula (1), one of R¹¹ and R¹² represents a linear alkyl group having 7 or more carbon atoms, and another thereof represents a linear alkyl group having 1 or more and 4 or less carbon atoms.

In addition, according to one aspect of the present disclosure, there is provided a production method for an electrophotographic photosensitive member, the production method including: preparing a coating liquid for a surface layer containing a composition containing a hole-transportable compound having a chain-polymerizable functional group and a compound represented by the following formula (1); forming a coat of the coating liquid for a surface layer; and curing the coat to form a surface layer:

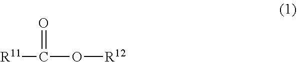

in the formula (1), one of R¹¹ and R¹² represents a linear alkyl group having 7 or more carbon atoms, and another thereof represents a linear alkyl group having 1 or more and 4 or less carbon atoms.

In addition, according to one aspect of the present disclosure, there is provided a process cartridge including: the electrophotographic photosensitive member; and at least one unit selected from the group consisting of a charging unit, a developing unit, and a cleaning unit, the process cartridge integrally supporting the electrophotographic photosensitive member and the at least one unit, and being removably mounted onto a main body of an electrophotographic image-forming apparatus.

In addition, according to one aspect of the present disclosure, there is provided an electrophotographic image-forming apparatus including: the electrophotographic photosensitive member; and at least one unit selected from the group consisting of a charging unit, an exposing unit, a developing unit, and a transferring unit.

Further features of the present invention will become apparent from the following description of exemplary embodiments with reference to the attached drawings.

### BRIEF DESCRIPTION OF THE DRAWINGS

FIG. 1 is a view for illustrating an example of the schematic construction of an electrophotographic image-forming apparatus including a process cartridge including an electrophotographic photosensitive member according to one aspect of the present disclosure.

FIG. 2 is a view for illustrating an example of the layer construction of the electrophotographic photosensitive member according to one aspect of the present disclosure.

FIG. 3 is a view for illustrating an example of a pressure-contact shape transfer processing apparatus configured to form depressed portions on the surface of the electrophotographic photosensitive member according to one aspect of the present disclosure.

FIG. 4A is a top view for illustrating a mold for forming depressed portions used in Examples and Comparative Examples of the present disclosure. FIG. 4B and FIG. 4C are each a schematic sectional view of the mold for forming depressed portions used in Examples and Comparative Examples of the present disclosure.

### DESCRIPTION OF THE EMBODIMENTS

The present inventors have made extensive investigations, and as a result, have found that a reduction in thickness of the electrophotographic photosensitive member described in Japanese Patent Application Laid-Open No. 2002-268250 at the time of its repeated use is large, and hence the lifetime of the electrophotographic photosensitive member is not sufficient. In addition, the electrophotographic photosensitive member described in Japanese Patent Application Laid-Open No. 2000-66425 is improved in wear resistance, but meanwhile, a streak-like image failure (image streak) caused by the insufficiency of the lubricity of the surface of the electrophotographic photosensitive member at the time of its repeated use has been remarkable. Therefore, it is an object of the present disclosure to provide an electrophotographic photosensitive member that can achieve both of satisfactory wear resistance and the suppression of an image streak at the time of its repeated use, and a production method for the electrophotographic photosensitive member. It is another object of the present disclosure to provide a process cartridge and an electrophotographic apparatus each including the electrophotographic photosensitive member.

The present disclosure is described in detail below by way of a preferred embodiment.

An electrophotographic photosensitive member according to one aspect of the present disclosure includes a surface layer containing: a polymer of a hole-transportable compound having a chain-polymerizable functional group; and a compound represented by the following formula (1):

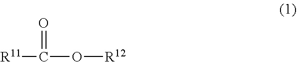

in the formula (1), one of R¹¹ and R¹² represents a linear alkyl group having 7 or more carbon atoms, and another thereof represents a linear alkyl group having 1 or more and 4 or less carbon atoms.

The present inventors presume as described below.

An image streak occurring at the time of repeated use of an electrophotographic photosensitive member is assumed to be caused by the destabilization of the behavior of a cleaning unit (e.g., a cleaning blade) due to the fusion of, for example, a substance forming a developer to the surface of the electrophotographic photosensitive member. The inventors have assumed that an image streak occurs in the electrophotographic photosensitive member described in Japanese Patent Application Laid-Open No. 2000-66425 because of the foregoing reason.

The compound represented by the formula (1) to be incorporated into the surface layer of the electrophotographic photosensitive member according to one aspect of the present disclosure has the linear alkyl group having 7 or more carbon atoms (hereinafter sometimes referred to as “long-chain alkyl group”). Probably under the influence of the long-chain alkyl group, the lubricity of the surface of the electrophotographic photosensitive member according to one aspect of the present disclosure is improved, and hence the behavior of a cleaning unit is stabilized to suppress the occurrence of an image streak.

In addition, the electrophotographic photosensitive member described in Japanese Patent Application Laid-Open No. 2000-66425 contains, in its surface layer, the cured product of the hole-transportable compound having a chain-polymerizable functional group. The cured product has the three-dimensional crosslinked structure, and hence a film serving as the surface layer may be improved in film density to express satisfactory wear resistance. Meanwhile, at the time of the curing of the compound, strain in the film may occur along with the curing shrinkage thereof. The suppression of the strain in the film may improve the film density of the surface layer to further improve the wear resistance.

The compound represented by the formula (1) also has the linear alkyl group having 1 or more and 4 or less carbon atoms (hereinafter sometimes referred to as “short-chain alkyl group”). The compound has both of alkyl groups having different lengths, that is, the long-chain alkyl group and the short-chain alkyl group, and hence compatibility between the compound and the hole-transportable compound having a chain-polymerizable functional group to be incorporated into the surface layer is satisfactory. Accordingly, the compound represented by the formula (1) easily enters a void in a three-dimensional crosslinked structure at the time of the curing of the hole-transportable compound, and hence strain in a film serving as the surface layer is suppressed. Probably as a result of the foregoing, the surface layer of the electrophotographic photosensitive member according to one aspect of the present disclosure is improved in film density to express satisfactory wear resistance.

The polymer of the hole-transportable compound having a chain-polymerizable functional group and the compound represented by the formula (1) to be incorporated into the surface layer of the electrophotographic photosensitive member according to one aspect of the present disclosure exhibit a synergistic effect like the foregoing mechanism, and hence the photosensitive member achieves the following effect: the photosensitive member can achieve both of satisfactory wear resistance and the suppression of an image streak at the time of its repeated use.

It is preferred that in the formula (1), one of R¹¹ and R¹² represent a linear alkyl group having 7 or more and 18 or less carbon atoms, and the other thereof represent a linear alkyl group having 1 or more and 4 or less carbon atoms. In addition, it is more preferred that in the formula (1), one of R¹¹ and R¹² represent an undecyl group, and the other thereof represent a n-propyl group. In this case, the compatibility between the compound represented by the formula (1) and the hole-transportable compound having a chain-polymerizable functional group becomes more satisfactory, and hence the wear resistance is improved.

Further, it is preferred that in the formula (1), R¹¹ represent a linear alkyl group having 7 or more carbon atoms, and R¹² represent a linear alkyl group having 1 or more and 4 or less carbon atoms.

Specific examples of the compound represented by the formula (1) (Exemplified Compounds 1-1 to 1-24) are given in Table 1, but the present disclosure is not limited thereto.

TABLE 1

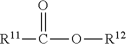

| Exemplified | | |
|---|---|---|
| Compound | R¹¹ | R¹² |
| (1-1) | CH₃(CH₂)₆ | CH₃ |
| (1-2) | CH₃(CH₂)₆ | CH₃CH₂ |
| (1-3) | CH₃(CH₂)₆ | CH₃(CH₂)₂ |
| (1-4) | CH₃(CH₂)₆ | CH₃(CH₂)₃ |
| (1-5) | CH₃(CH₂)₁₀ | CH₃ |
| (1-6) | CH₃(CH₂)₁₀ | CH₃CH₂ |
| (1-7) | CH₃(CH₂)₁₀ | CH₃(CH₂)₂ |
| (1-8) | CH₃(CH₂)₁₀ | CH₃(CH₂)₃ |
| (1-9) | CH₃(CH₂)₁₇ | CH₃ |
| (1-10) | CH₃(CH₂)₁₇ | CH₃CH₂ |
| (1-11) | CH₃(CH₂)₁₇ | CH₃(CH₂)₂ |
| (1-12) | CH3(CH₂)₁₇ | CH₃(CH₂)₃ |
| (1-13) | CH₃ | CH₃(CH₂)₆ |
| (1-14) | CH₃CH₂ | CH₃(CH₂)₆ |
| (1-15) | CH₃(CH₂)₂ | CH₃(CH₂)₆ |
| (1-16) | CH₃(CH₂)₃ | CH₃(CH₂)₆ |
| (1-17) | CH₃ | CH₃(CH₂)₁₀ |
| (1-18) | CH₃CH₂ | CH₃(CH₂)₁₀ |
| (1-19) | CH₃(CH₂)₂ | CH₃(CH₂)₁₀ |
| (1-20) | CH₃(CH₂)₃ | CH₃(CH₂)₁₀ |
| (1-21) | CH₃ | CH₃(CH₂)₁₇ |
| (1-22) | CH₃CH₂ | CH₃(CH₂)₁₇ |
| (1-23) | CH₃(CH₂)₂ | CH₃(CH₂)₁₇ |
| (1-24) | CH₃(CH₂)₃ | CH₃(CH₂)₁₇ |

It is preferred that the surface layer contain a copolymer of the hole-transportable compound having a chain-polymerizable functional group and a compound represented by the following formula (2):

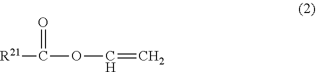

in the formula (2), R²¹ represents a linear alkyl group having 7 or more carbon atoms.

The compound represented by the formula (2) has a vinyl ester group that can be subjected to chain polymerization, and hence can be copolymerized with the hole-transportable compound having a chain-polymerizable functional group. Thus, the three-dimensional crosslinked structure in the surface layer is more densely formed, and hence the film density of the surface layer is improved and more satisfactory wear resistance is obtained.

It is preferred that in the formula (2), R²¹ represent a linear alkyl group having 9 or more and 13 or less carbon atoms. In this case, the compatibility between the compound represented by the formula (2) and the hole-transportable compound having a chain-polymerizable functional group becomes more satisfactory, and hence the wear resistance is improved.

Specific examples of the compound represented by the formula (2) (Exemplified Compounds 2-1 to 2-6) are given in Table 2, but the present disclosure is not limited thereto.

TABLE 2

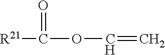

| Exemplified Compound | R²¹ |
|---|---|
| (2-1) | CH₃(CH₂)₆ |
| (2-2) | CH₃(CH₂)₈ |
| (2-3) | CH₃(CH₂)₁₀ |
| (2-4) | CH₃(CH₂)₁₂ |
| (2-5) | CH₃(CH₂)₁₄ |
| (2-6) | CH₃(CH₂)₁₆ |

It is preferred that the surface layer contain a siloxane-modified (meth)acrylic compound. Thus, the lubricity of the surface of the electrophotographic photosensitive member is further improved, and hence a more satisfactory image streak-suppressing effect is obtained. The siloxane-modified (meth)acrylic compound is a compound obtained by introducing a siloxane as a side chain into a (meth)acrylic polymer, and is obtained by, for example, copolymerizing a (meth)acrylic monomer and a siloxane having a (meth)acrylic group. A purchasable siloxane-modified (meth)acrylic compound is, for example, BYK-3550 manufactured by BYK-Chemie Japan or US-270 manufactured by Toagosei Co., Ltd. The content of the siloxane-modified (meth)acrylic compound is preferably 0.1 mass % or more and 5 mass % or less with respect to the total mass of the hole-transportable compound having a chain-polymerizable functional group and the compound represented by the formula (1).

The term “(meth)acrylic compound” as used herein means an “acrylic compound” and/or a “methacrylic compound”. In addition, the term “(meth)acrylic polymer” includes a polymer of the “acrylic compound”, a polymer of the “methacrylic compound”, and a polymer of the “acrylic compound” and the “methacrylic compound”.

It is preferred that the hole-transportable compound having a chain-polymerizable functional group include a compound represented by the following formula (3):

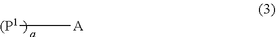

in the formula (3), A represents a hole-transportable group, P¹ represents an acryloyloxy group or a methacryloyloxy group, “a” represents an integer of from 2 to 4, and P¹s may be identical to or different from each other, and a hydrogen adduct obtained by replacing a bonding site of the A to P¹ with a hydrogen atom has a structure represented by the following formula (4) or a structure represented by the following formula (5):

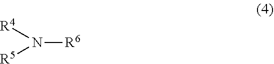

in the formula (4), R⁴, R⁵, and R⁶ each represent a phenyl group that may have an alkyl group having 1 to 6 carbon atoms as a substituent, and R⁴, R⁵, and R⁶ may be identical to or different from each other;

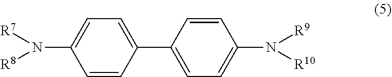

in the formula (5), R⁷, R⁸, R⁹, and R¹⁰ each represent a phenyl group that may have an alkyl group having 1 to 6 carbon atoms as a substituent, and R⁷, R⁸, R⁹, and R¹⁰ may be identical to or different from each other.

In addition, the surface layer of the electrophotographic photosensitive member according to one aspect of the present disclosure may contain an additive, such as an antioxidant, a UV absorber, a plasticizer, a leveling agent, a lubricity-imparting agent, or a wear resistance-improving agent. Specific examples thereof include a hindered phenol compound, a hindered amine compound, a sulfur compound, a phosphorus compound, a benzophenone compound, a silicone oil, fluorine resin particles, polystyrene resin particles, polyethylene resin particles, silica particles, alumina particles, and boron nitride particles.

When the surface layer contains the additive, the content of the additive in the composition of the surface layer is preferably 50 mass % or less.

The average thickness of the surface layer is preferably 0.5 μm or more and m or less, more preferably 1 μm or more and 7 μm or less.

The surface layer of the electrophotographic photosensitive member according to one aspect of the present disclosure may be formed through the steps of: preparing a coating liquid for a surface layer containing the hole-transportable compound having a chain-polymerizable functional group and the compound represented by the formula (1); forming a coat of the coating liquid for a surface layer on the surface of the electrophotographic photosensitive member; and curing the coat to form the surface layer.

Although the blending amounts of the hole-transportable compound having a chain-polymerizable functional group, the compound represented by the formula (1), and the compound represented by the formula (2) in the coating liquid for a surface layer are not particularly limited, when the mass of the hole-transportable compound is represented by Wa, the mass of the compound represented by the formula (1) is represented by Wb, and the mass of the compound represented by the formula (2) is represented by Wc, a relationship of 0.05<Wb/(Wa+Wb+Wc)<0.20 or 0.05<Wc/(Wa+Wb+Wc)<0.20 is preferably satisfied, and a relationship of 0.10<(Wb+Wc)/(Wa+Wb+Wc)<0.30 is more preferably satisfied.

A solvent that does not dissolve a layer to be arranged below the surface layer is preferably used as a solvent to be used for the preparation of the coating liquid for a surface layer. The solvent is more preferably an alcohol-based solvent, such as methanol, ethanol, propanol, isopropanol, 1-butanol, 2-butanol, or 1-methoxy-2-propanol.

As a method of applying the coating liquid for a surface layer, there are given, for example, dip coating, spray coating, inkjet coating, roll coating, die coating, blade coating, curtain coating, wire bar coating, and ring coating. Of those, a method using dip coating is preferred from the viewpoints of efficiency and productivity.

As a method of curing the coat of the coating liquid for a surface layer, there is given a method involving curing the coat with heat, UV light, or electron beams. In order to maintain the strength of the surface layer and the durability of the electrophotographic photosensitive member, the coat is preferably cured using UV light or electron beams.

The coat is preferably polymerized using electron beams because an extremely dense (high-density) cured product (three-dimensional crosslinked structure) is obtained, and hence a surface layer having higher durability is obtained. When the coat is irradiated with electron beams, as an accelerator, there are given, for example, a scanning type, an electrocurtain type, a broad-beam type, a pulse type, and a laminar type.

When electron beams are used, the acceleration voltage of the electron beams is preferably 120 kV or less from the viewpoint that the deterioration of material characteristics due to the electron beams can be suppressed without impairing polymerization efficiency. In addition, the absorbed dose of the electron beams at the surface of the coat of the coating liquid for a surface layer is preferably 1 kGy or more and 50 kGy or less, more preferably 5 kGy or more and 10 kGy or less.

In addition, when the coat is cured (polymerized) using electron beams, it is preferred that the coat be irradiated with the electron beams in an inert gas atmosphere and then heated in an inert gas atmosphere for the purpose of suppressing the polymerization-inhibiting action of oxygen. Examples of the inert gas include nitrogen, argon, and helium.

In addition, after the irradiation with UV light or electron beams, the electrophotographic photosensitive member is preferably heated to 100° C. or more and 170° C. or less. With this, a surface layer that has still higher durability and suppresses an image failure is obtained.

Next, the construction of the electrophotographic photosensitive member according to one aspect of the present disclosure is described. In addition, while each construction of the electrophotographic photosensitive member is described, a production method therefor is also described.

[Electrophotographic Photosensitive Member]

An electrophotographic photosensitive member according to one aspect of the present disclosure includes a support, a photosensitive layer, and a surface layer (protective layer) in the stated order.

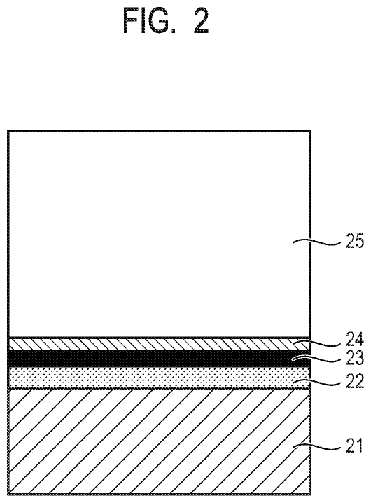

FIG. 2 is a view for illustrating an example of the layer construction of the electrophotographic photosensitive member. In FIG. 2, the electrophotographic photosensitive member includes a support 21, an undercoat layer 22, a charge-generating layer 23, a charge-transporting layer 24, and a protective layer 25. In this case, the charge-generating layer 23 and the charge-transporting layer 24 form the photosensitive layer, and the protective layer 25 serves as the surface layer.

A method of producing the electrophotographic photosensitive member is, for example, a method involving: preparing coating liquids for the respective layers to be described later; applying the liquids in a desired layer order; and drying the liquids. At this time, any of the methods given as the above-mentioned method of applying the coating liquid for a surface layer may be used as a method of applying each of the liquids. Of those, dip coating is preferred from the viewpoints of efficiency and productivity.

The support and the respective layers are described below.

<Support>

The electrophotographic photosensitive member according to one aspect of the present disclosure includes the support 21. The support is preferably a conductive support having conductivity. In addition, examples of the shape of the support include a cylindrical shape, a belt shape, and a sheet shape. Of those, a cylindrical support is preferred. In addition, the surface of the support may be subjected to, for example, an electrochemical treatment, such as anodization, a blast treatment, or a cutting treatment.

A metal, a resin, glass, or the like is preferred as a material for the support 21.

Examples of the metal include aluminum, iron, nickel, copper, gold, and stainless steel, and alloys thereof. Of those, an aluminum support using aluminum is preferred.

In addition, conductivity may be imparted to the resin or the glass through a treatment involving, for example, mixing or coating the resin or the glass with a conductive material.

<Conductive Layer>

In one aspect of the present disclosure, a conductive layer may be arranged on the support 21. The arrangement of the conductive layer can conceal flaws and irregularities in the surface of the support, and control the reflection of light on the surface of the support.

The conductive layer preferably contains conductive particles and a resin.

A material for the conductive particles is, for example, a metal oxide, a metal, or carbon black. Examples of the metal oxide include zinc oxide, aluminum oxide, indium oxide, silicon oxide, zirconium oxide, tin oxide, titanium oxide, magnesium oxide, antimony oxide, and bismuth oxide. Examples of the metal include aluminum, nickel, iron, nichrome, copper, zinc, and silver.

Of those, a metal oxide is preferably used as the conductive particles, and in particular, titanium oxide, tin oxide, and zinc oxide are more preferably used.

When the metal oxide is used as the conductive particles, the surface of the metal oxide may be treated with a silane coupling agent or the like, or the metal oxide may be doped with an element, such as phosphorus or aluminum, or an oxide thereof.

In addition, each of the conductive particles may be of a laminated construction having a core particle and a coating layer coating the particle. Examples of the core particle include titanium oxide, barium sulfate, and zinc oxide. The coating layer is, for example, a metal oxide, such as tin oxide.

In addition, when the metal oxide is used as the conductive particles, their volume-average particle diameter is preferably 1 nm or more and 500 nm or less, more preferably 3 nm or more and 400 nm or less.

Examples of the resin include a polyester resin, a polycarbonate resin, a polyvinyl acetal resin, an acrylic resin, a silicone resin, an epoxy resin, a melamine resin, a polyurethane resin, a phenol resin, and an alkyd resin.

In addition, the conductive layer may further contain a concealing agent, such as a silicone oil, resin particles, or titanium oxide.

The average thickness of the conductive layer is preferably 1 μm or more and 50 μm or less, particularly preferably 3 μm or more and 40 μm or less.

The conductive layer may be formed by: preparing a coating liquid for a conductive layer containing the above-mentioned respective materials and a solvent; forming a coat of the coating liquid; and drying the coat. Examples of the solvent to be used for the coating liquid include an alcohol-based solvent, a sulfoxide-based solvent, a ketone-based solvent, an ether-based solvent, an ester-based solvent, and an aromatic hydrocarbon-based solvent. As a dispersion method for dispersing the conductive particles in the coating liquid for a conductive layer, there are given methods using a paint shaker, a sand mill, a ball mill, and a liquid collision-type high-speed disperser.

<Undercoat Layer>

In one aspect of the present disclosure, the undercoat layer 22 may be arranged on the support 21 or the conductive layer. The arrangement of the undercoat layer 22 can improve an adhesive function between layers to impart a charge injection-inhibiting function.

The undercoat layer 22 preferably contains a resin. In addition, the undercoat layer 22 may be formed as a cured film by polymerizing a composition containing a monomer having a polymerizable functional group.

Examples of the resin include a polyester resin, a polycarbonate resin, a polyvinyl acetal resin, an acrylic resin, an epoxy resin, a melamine resin, a polyurethane resin, a phenol resin, a polyvinyl phenol resin, an alkyd resin, a polyvinyl alcohol resin, a polyethylene oxide resin, a polypropylene oxide resin, a polyamide resin, a polyamide acid resin, a polyimide resin, a polyamide imide resin, and a cellulose resin.

Examples of the polymerizable functional group of the monomer having a polymerizable functional group include an isocyanate group, a blocked isocyanate group, a methylol group, an alkylated methylol group, an epoxy group, a metal alkoxide group, a hydroxyl group, an amino group, a carboxyl group, a thiol group, a carboxylic acid anhydride group, and a carbon-carbon double bond group.

In addition, the undercoat layer 22 may further contain an electron-transporting substance, a metal oxide, a metal, a conductive polymer, and the like for the purpose of improving electric characteristics. Of those, an electron-transporting substance and a metal oxide are preferably used.

Examples of the electron-transporting substance include a quinone compound, an imide compound, a benzimidazole compound, a cyclopentadienylidene compound, a fluorenone compound, a xanthone compound, a benzophenone compound, a cyanovinyl compound, a halogenated aryl compound, a silole compound, and a boron-containing compound. An electron-transporting substance having a polymerizable functional group may be used as the electron-transporting substance and copolymerized with the above-mentioned monomer having a polymerizable functional group to form the undercoat layer 22 as a cured film.

Examples of the metal oxide include indium tin oxide, tin oxide, indium oxide, titanium oxide, zinc oxide, aluminum oxide, and silicon dioxide. Examples of the metal include gold, silver, and aluminum.

In addition, the undercoat layer 22 may further contain an additive.

The average thickness of the undercoat layer 22 is preferably 0.1 μm or more and 50 μm or less, more preferably 0.2 μm or more and 40 μm or less, particularly preferably 0.3 μm or more and 30 μm or less.

The undercoat layer 22 may be formed by: preparing a coating liquid for an undercoat layer containing the above-mentioned respective materials and a solvent; forming a coat of the coating liquid; and drying and/or curing the coat. Examples of the solvent to be used for the coating liquid include an alcohol-based solvent, a ketone-based solvent, an ether-based solvent, an ester-based solvent, and an aromatic hydrocarbon-based solvent.

<Photosensitive Layer>

The photosensitive layers of electrophotographic photosensitive members are mainly classified into (1) a laminated photosensitive layer and (2) a single-layer photosensitive layer. (1) The laminated photosensitive layer has a charge-generating layer 23 containing a charge-generating substance and a charge-transporting layer 24 containing a charge-transporting substance. (2) The single-layer photosensitive layer is a photosensitive layer containing both a charge-generating substance and a charge-transporting substance.

(1) Laminated Photosensitive Layer

The laminated photosensitive layer has the charge-generating layer 23 and the charge-transporting layer 24.

(1-1) Charge-Generating Layer

The charge-generating layer 23 preferably contains the charge-generating substance and a resin.

Examples of the charge-generating substance include azo pigments, perylene pigments, polycyclic quinone pigments, indigo pigments, and phthalocyanine pigments. Of those, azo pigments and phthalocyanine pigments are preferred. Of the phthalocyanine pigments, an oxytitanium phthalocyanine pigment, a chlorogallium phthalocyanine pigment, and a hydroxygallium phthalocyanine pigment are preferred.

The content of the charge-generating substance in the charge-generating layer 23 is preferably 40 mass % or more and 85 mass % or less, more preferably 60 mass % or more and 80 mass % or less with respect to the total mass of the charge-generating layer 23.

Examples of the resin include a polyester resin, a polycarbonate resin, a polyvinyl acetal resin, a polyvinyl butyral resin, an acrylic resin, a silicone resin, an epoxy resin, a melamine resin, a polyurethane resin, a phenol resin, a polyvinyl alcohol resin, a cellulose resin, a polystyrene resin, a polyvinyl acetate resin, and a polyvinyl chloride resin. Of those, a polyvinyl butyral resin is more preferred.

In addition, the charge-generating layer 23 may further contain an additive, such as an antioxidant or a UV absorber. Specific examples thereof include a hindered phenol compound, a hindered amine compound, a sulfur compound, a phosphorus compound, and a benzophenone compound.

The average thickness of the charge-generating layer 23 is preferably 0.1 Lm or more and 1 μm or less, more preferably 0.15 Lm or more and 0.4 μm or less.

The charge-generating layer 23 may be formed by: preparing a coating liquid for a charge-generating layer containing the above-mentioned respective materials and a solvent; forming a coat of the coating liquid; and drying the coat. Examples of the solvent to be used for the coating liquid include an alcohol-based solvent, a sulfoxide-based solvent, a ketone-based solvent, an ether-based solvent, an ester-based solvent, and an aromatic hydrocarbon-based solvent.

(1-2) Charge-Transporting Layer

The charge-transporting layer 24 preferably contains the charge-transporting substance and a resin.

Examples of the charge-transporting substance include a polycyclic aromatic compound, a heterocyclic compound, a hydrazone compound, a styryl compound, an enamine compound, a benzidine compound, a triarylamine compound, and a resin having a group derived from each of those substances. Of those, a triarylamine compound and a benzidine compound are preferred.

The content of the charge-transporting substance in the charge-transporting layer 24 is preferably 25 mass % or more and 70 mass % or less, more preferably 30 mass % or more and 55 mass % or less with respect to the total mass of the charge-transporting layer 24.

Examples of the resin include a polyester resin, a polycarbonate resin, an acrylic resin, and a polystyrene resin. Of those, a polycarbonate resin and a polyester resin are preferred. A polyarylate resin is particularly preferred as the polyester resin.

A content ratio (mass ratio) between the charge-transporting substance and the resin is preferably from 4:10 to 20:10, more preferably from 5:10 to 12:10.

In addition, the charge-transporting layer 24 may contain an additive, such as an antioxidant, a UV absorber, a plasticizer, a leveling agent, a lubricity-imparting agent, or a wear resistance-improving agent. Specific examples thereof include a hindered phenol compound, a hindered amine compound, a sulfur compound, a phosphorus compound, a benzophenone compound, a siloxane-modified resin, a silicone oil, fluorine resin particles, polystyrene resin particles, polyethylene resin particles, silica particles, alumina particles, and boron nitride particles.

The average thickness of the charge-transporting layer 24 is preferably 5 μm or more and 50 μm or less, more preferably 8 μm or more and 40 μm or less, particularly preferably 10 μm or more and 30 μm or less.

The charge-transporting layer 24 may be formed by: preparing a coating liquid for a charge-transporting layer containing the above-mentioned respective materials and a solvent; forming a coat of the coating liquid; and drying the coat. Examples of the solvent to be used for the coating liquid include an alcohol-based solvent, a ketone-based solvent, an ether-based solvent, an ester-based solvent, and an aromatic hydrocarbon-based solvent. Of those solvents, an ether-based solvent or an aromatic hydrocarbon-based solvent is preferred.

(2) Single-layer Photosensitive Layer

The single-layer photosensitive layer may be formed by: preparing a coating liquid for a photosensitive layer containing the charge-generating substance, the charge-transporting substance, a resin, and a solvent; forming a coat of the coating liquid; and drying the coat. Examples of the charge-generating substance, the charge-transporting substance, and the resin are the same as those of the materials in the section “(1) Laminated Photosensitive Layer.”

The average thickness of the single-layer photosensitive layer is preferably Lm or more and 50 μm or less, more preferably 8 Lm or more and 40 μm or less, particularly preferably 10 μm or more and 30 μm or less.

<Protective Layer>

The protective layer 25 may be formed, as described above, through the steps of: preparing a coating liquid for a surface layer; forming a coat of the coating liquid for a surface layer on the photosensitive layer; and curing the coat.

[Method of forming Surface Shape of Electrophotographic Photosensitive Member]

For the purpose of further stabilizing the behavior of a cleaning blade to be brought into contact with the electrophotographic photosensitive member, it is more preferred that depressed portions or projected portions be formed on the surface layer of the electrophotographic photosensitive member.

The depressed portions or the projected portions may be formed over the entirety of the surface of the electrophotographic photosensitive member, or may be formed on part of the surface of the electrophotographic photosensitive member. When the depressed portions or the projected portions are formed on part of the surface of the electrophotographic photosensitive member, it is preferred that the depressed portions or the projected portions be formed at least over the entirety of a region with which the cleaning blade is to be brought into contact.

For example, when the depressed portions are formed, the depressed portions may be formed by bringing a mold having projections corresponding to the depressed portions to be formed into pressure contact with the surface of the electrophotographic photosensitive member to perform shape transfer.

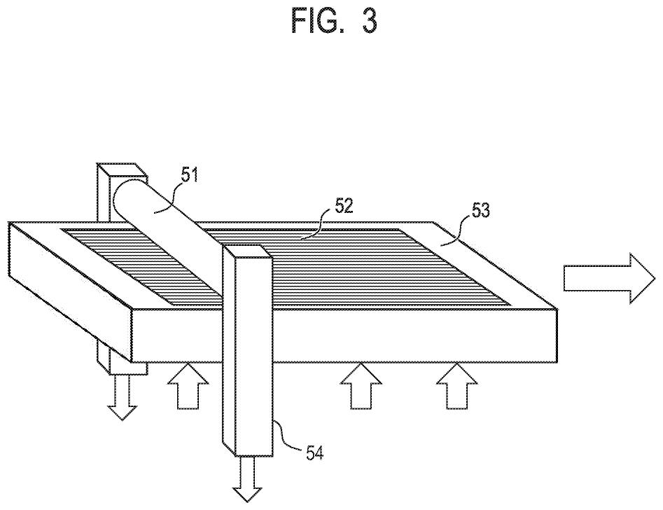

FIG. 3 is an illustration of an example of a pressure-contact shape transfer processing apparatus configured to form depressed portions on the surface of the electrophotographic photosensitive member.

The pressure-contact shape transfer processing apparatus illustrated in FIG. 3 is configured such that, while an electrophotographic photosensitive member 51 serving as an object to be processed is rotated, a mold 52 is continuously brought into contact with its surface (circumferential surface) to pressurize the surface, and thus depressed portions or flat portions can be formed on the surface of the electrophotographic photosensitive member 51.

As a material for a pressurizing member 53, there are given, for example, a metal, a metal oxide, a plastic, and glass. Of those, stainless steel (SUS) is preferred from the viewpoints of mechanical strength, dimensional accuracy, and durability. The mold 52 is placed on the upper surface of the pressurizing member 53. In addition, a supporting member (not shown) and a pressurizing system (not shown) that are placed on a lower surface side allow the mold 52 to be brought into contact at a predetermined pressure with the surface of the electrophotographic photosensitive member 51 supported by a supporting member 54. In addition, the supporting member 54 may be pressed against the pressurizing member 53 at a predetermined pressure, or the supporting member 54 and the pressurizing member 53 may be pressed against each other.

The example illustrated in FIG. 3 is an example in which the pressurizing member 53 is moved in a direction perpendicular to the axial direction of the electrophotographic photosensitive member 51, to thereby continuously process its surface while the electrophotographic photosensitive member 51 follows the movement or is driven to rotate. Further, the surface of the electrophotographic photosensitive member 51 may also be continuously processed by fixing the pressurizing member 53 and moving the supporting member 54 in a direction perpendicular to the axial direction of the electrophotographic photosensitive member 51, or by moving both of the supporting member 54 and the pressurizing member 53.

From the viewpoint of efficiently performing the shape transfer, the mold 52 and the electrophotographic photosensitive member 51 are preferably heated.

Examples of the mold 52 include: a metal having a finely processed surface; a product obtained by patterning the surface of a resin film, a silicon wafer, or the like with a resist; and a product obtained by applying a metal coating to a resin film having dispersed therein fine particles or a resin film having a fine surface shape.

In addition, from the viewpoint of uniformizing the pressure at which the mold 52 is pressed against the electrophotographic photosensitive member 51, it is preferred that an elastic body be placed between the mold 52 and the pressurizing member 53.

[Process Cartridge and Electrophotographic Apparatus]

A process cartridge according to one aspect of the present disclosure integrally supports the electrophotographic photosensitive member according to one aspect of the present disclosure, and at least one unit selected from the group consisting of a charging unit, a developing unit, and a cleaning unit, and is removably mounted onto the main body of an electrophotographic apparatus.

In addition, an electrophotographic apparatus according to one aspect of the present disclosure includes the electrophotographic photosensitive member according to one aspect of the present disclosure, and at least one unit selected from the group consisting of a charging unit, an exposing unit, a developing unit, and a transferring unit.

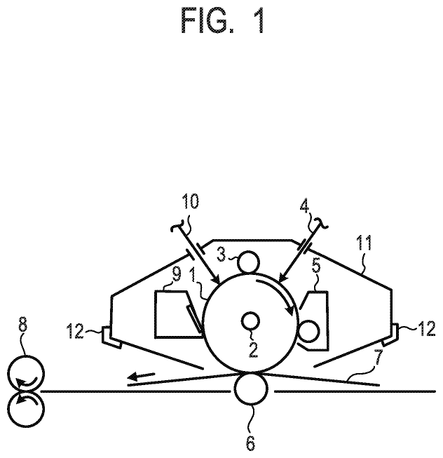

An example of the schematic construction of an electrophotographic image-forming apparatus including a process cartridge including an electrophotographic photosensitive member is illustrated in FIG. 1.

A cylindrical electrophotographic photosensitive member 1 is rotationally driven about a shaft 2 in a direction indicated by the arrow at a predetermined peripheral speed. The surface of the electrophotographic photosensitive member 1 is charged to a predetermined positive or negative potential by a charging unit 3. In FIG. 1, a roller charging system based on a roller-type charging member is illustrated, but a charging system such as a corona charging system, a proximity charging system, or an injection charging system may be adopted. The charged surface of the electrophotographic photosensitive member 1 is irradiated with exposure light 4 from an exposing unit (not shown), and hence an electrostatic latent image corresponding to target image information is formed thereon. The electrostatic latent image formed on the surface of the electrophotographic photosensitive member 1 is developed with a toner stored in a developing unit 5, and a toner image is formed on the surface of the electrophotographic photosensitive member 1. The toner image formed on the surface of the electrophotographic photosensitive member 1 is transferred onto a transfer material 7 by a transferring unit 6. The transfer material 7 onto which the toner image has been transferred is conveyed to a fixing unit 8, is subjected to a treatment for fixing the toner image, and is printed out to the outside of the electrophotographic apparatus. The electrophotographic apparatus may include a cleaning unit 9 for removing a deposit, such as the toner remaining on the surface of the electrophotographic photosensitive member 1 after the transfer. In addition, a so-called cleaner-less system configured to remove the deposit with the developing unit 5 or the like without separate arrangement of the cleaning unit 9 may be used. The electrophotographic image-forming apparatus may include an electricity-removing mechanism configured to subject the surface of the electrophotographic photosensitive member 1 to an electricity-removing treatment with pre-exposure light 10 from a pre-exposing unit (not shown). In addition, a guiding unit 12, such as a rail, may be arranged for removably mounting a process cartridge 11 according to one aspect of the present disclosure onto the main body of an electrophotographic image-forming apparatus.

The electrophotographic photosensitive member according to one aspect of the present disclosure can be used in, for example, a laser beam printer, an LED printer, a copying machine, a facsimile, and a multifunctional peripheral thereof.

### EXAMPLES

The present disclosure is described in more detail below by way of Examples and Comparative Examples. The present disclosure is by no means limited to the following Examples, and various modifications may be made without departing from the gist of the present disclosure. In the following Examples, “part(s)” is by mass unless otherwise specified.

### Example 1

An aluminum cylinder having a diameter of 30 mm, a length of 357.5 mm, and a thickness of 1 mm was used as a support (conductive support).

Next, 100 parts of zinc oxide particles (specific surface area: 19 m²/g, powder resistivity: 4.7×10⁶ Ω·cm) were mixed with 500 parts of toluene under stirring. 0.8 Part of a silane coupling agent was added to the mixture, and the whole was stirred for 6 hours. After that, toluene was evaporated under reduced pressure, and the residue was heated to dryness at 130° C. for 6 hours. Thus, surface-treated zinc oxide particles were obtained. N-2-(Aminoethyl)-3-aminopropylmethyldimethoxysilane (product name: KBM602, manufactured by Shin-Etsu Chemical Co., Ltd.) was used as the silane coupling agent.

Next, 15 parts of a polyvinyl butyral resin (product name: BM-1, manufactured by Sekisui Chemical Co., Ltd., weight-average molecular weight: 40,000) serving as a polyol resin and 15 parts of a blocked isocyanate (product name: Sumidur 3175, manufactured by Sumika Covestro Urethane Co., Ltd. (formerly Sumika Bayer Urethane Co., Ltd.)) were dissolved in a mixed solution of 73.5 parts of methyl ethyl ketone and 73.5 parts of 1-butanol. 80.8 Parts of the surface-treated zinc oxide particles and 0.8 part of 2,3,4-trihydroxybenzophenone (manufactured by Tokyo Chemical Industry Co., Ltd.) were added to the solution. The mixture was subjected to dispersion under an atmosphere at 23+3° C. for 3 hours with a sand mill apparatus using glass beads each having a diameter of 0.8 mm. After the dispersion, 0.01 part of a silicone oil (product name: SH28PA, manufactured by Dow Corning Toray Co., Ltd.) and 5.6 parts of crosslinked polymethyl methacrylate (PMMA) particles (product name: TECHPOLYMER SSX-103, manufactured by Sekisui Plastics Co., Ltd., average primary particle diameter: 3 μm) were added, and the mixture was stirred to prepare a coating liquid for an undercoat layer.

The coating liquid for an undercoat layer was applied onto the aluminum cylinder by dip coating to form a coat, and the resultant coat was dried for 40 minutes at 160° C. to form an undercoat layer having a thickness of 18 μm.

Next, a hydroxygallium phthalocyanine crystal of a crystal form having strong peaks at Bragg angles 20+0.2° in CuKα characteristic X-ray diffraction of 7.4° and 28.2° was prepared. 20 Parts of the hydroxygallium phthalocyanine crystal, 0.2 part of a compound represented by the following formula (A), 10 parts of a polyvinyl butyral resin (product name: S-LEC BX-1, manufactured by Sekisui Chemical Co., Ltd.), and 600 parts of cyclohexanone were dispersed with a sand mill apparatus using glass beads each having a diameter of 1 mm for 4 hours. After that, 700 parts of ethyl acetate was added to prepare a coating liquid for a charge-generating layer.

The coating liquid for a charge-generating layer was applied onto the undercoat layer by dip coating to form a coat, and the resultant coat was heated to dryness in an oven having a temperature of 80° C. for 15 minutes to form a charge-generating layer having a thickness of 0.17 μm.

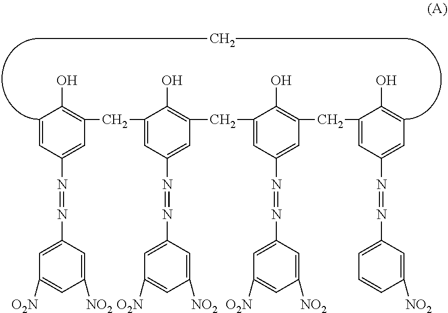

Next, 30 parts of a compound represented by the following formula (B) (charge-transporting substance), 60 parts of a compound represented by the following formula (C) (charge-transporting substance), 10 parts of a compound represented by the following formula (D), 100 parts of a polycarbonate resin (product name: Iupilon Z400, manufactured by Mitsubishi Engineering-Plastics Corporation, bisphenol Z type), and 0.02 part of polycarbonate having structural units represented by the following formula (E) (viscosity-average molecular weight Mv: 20,000) were dissolved in a mixed solvent of 600 parts of xylene and 200 parts of dimethoxymethane to prepare a coating liquid for a charge-transporting layer. The coating liquid for a charge-transporting layer was applied onto the charge-generating layer by dip coating to form a coat, and the resultant coat was dried for 30 minutes at 100° C. to form a charge-transporting layer having a thickness of 18 μm.

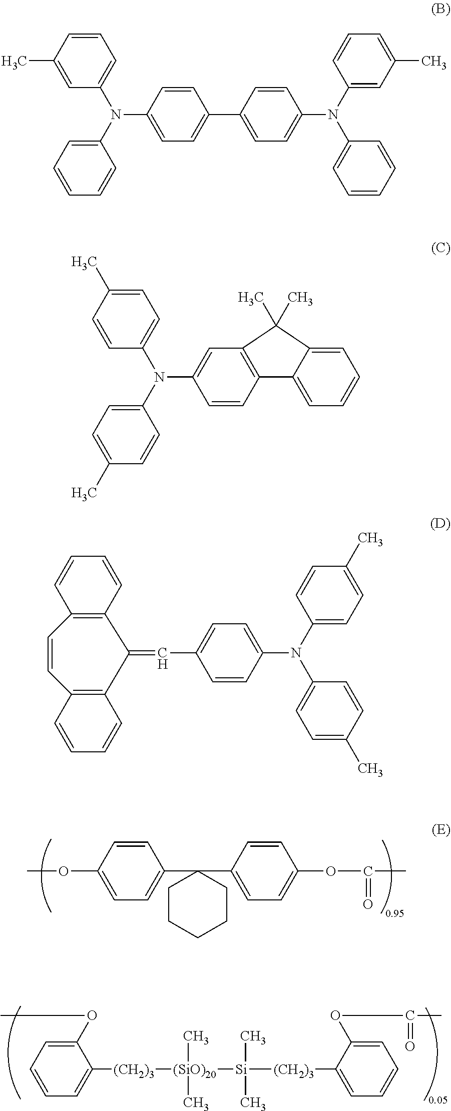

In the formula (E), 0.95 and 0.05 represent the molar ratios (copolymerization ratios) of the two structural units.

Next, 56 parts of a hole-transportable compound having a chain-polymerizable functional group represented by the following formula (F), 7 parts of Exemplified Compound (1-7) serving as a compound represented by the formula (1), 7 parts of Exemplified Compound (2-3) serving as a compound represented by the formula (2), 0.5 part of a siloxane-modified acrylic compound (product name: US-270, manufactured by Toagosei Co., Ltd.), 30 parts of polytetrafluoroethylene particles (product name: RUBURON L-2, manufactured by Daikin Industries, Ltd.), 1.5 parts of a fluorine atom-containing resin (product name: ARON GF-300, manufactured by Toagosei Co., Ltd.), 100 parts of 1-propanol, and 100 parts of 1,1,2,2,3,3,4-heptafluorocyclopentane (product name: ZEORORA-H, manufactured by Zeon Corporation) were mixed, and then the solution was subjected to a dispersion treatment with an ultrahigh-speed disperser. After that, the solution was filtered through a polyflon filter (product name: PF-060, manufactured by Advantec Toyo Kaisha, Ltd.) to prepare a coating liquid for a surface layer.

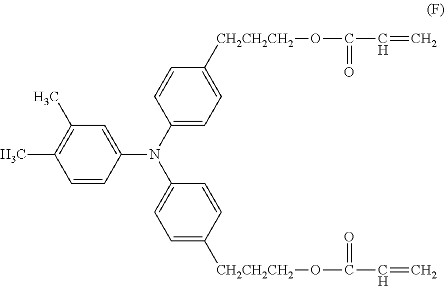

The coating liquid for a surface layer was applied onto the charge-transporting layer by dip coating to form a coat. The resultant coat was dried for 5 minutes at 50° C. Next, under a nitrogen atmosphere, the coat was irradiated with electron beams for 1.5 seconds under the conditions of an acceleration voltage of 70 kV and a beam current of 5.0 mA while the support (irradiated body) was rotated at a speed of 200 rpm, and then the temperature of the coat was increased from 25° C. to 130° C. over 15 seconds to cure the coat. The absorbed dose of the electron beams at this time was measured to be 15 kGy, and an oxygen concentration during a time period from the electron beam irradiation to the subsequent heating treatment was 16 ppm or less. Next, in the atmosphere, the coat was naturally cooled until its temperature became 25° C., and then a heating treatment was performed for 15 minutes at 100° C. to form a surface layer (protective layer) having a thickness of 5 μm.

Thus, an electrophotographic photosensitive member before depressed portion formation having a protective layer was produced.

Next, a mold member (mold) was placed in a pressure-contact shape transfer processing apparatus, and the produced electrophotographic photosensitive member before depressed portion formation was subjected to surface processing.

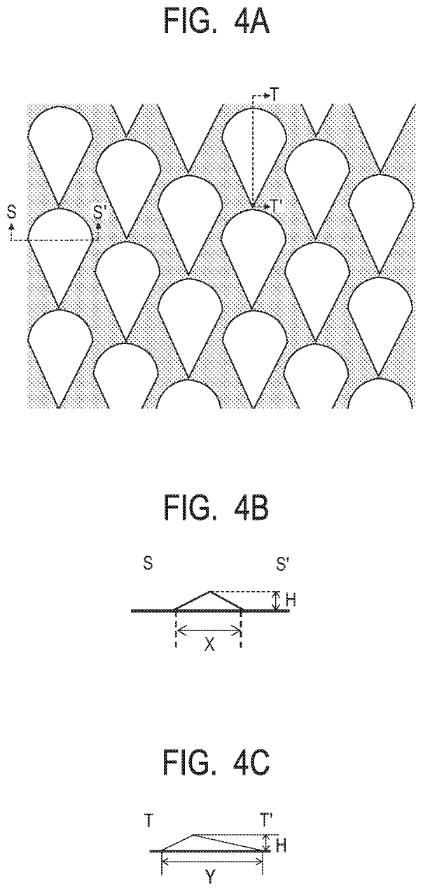

Specifically, a mold illustrated in FIG. 4A to FIG. 4C was placed in a pressure-contact shape transfer processing apparatus roughly having the construction illustrated in FIG. 3, and the produced electrophotographic photosensitive member before depressed portion formation was subjected to surface processing. FIG. 4A to FIG. 4C are views for illustrating the mold used in Examples and Comparative Examples, FIG. 4A is a top view for schematically illustrating the mold, FIG. 4B is a schematic cross-sectional view of a projection of the mold in the axial direction of the electrophotographic photosensitive member (cross-sectional view of a cross-section taken along the line S-S′ of FIG. 4A), and FIG. 4C is a cross-sectional view of a projection of the mold in the circumferential direction of the electrophotographic photosensitive member (cross-sectional view of a cross-section taken along the line T-T′ of FIG. 4A). The mold illustrated in FIG. 4A to FIG. 4C has projection shapes having a maximum width X (maximum width in the axial direction of the electrophotographic photosensitive member when a projection on the mold is viewed from above) of 50 μm, a maximum length Y (maximum length in the circumferential direction of the electrophotographic photosensitive member when a projection on the mold is viewed from above) of 75 μm, an area ratio of 56%, and a height H of 4 μm. The area ratio refers to the ratio of the area of the projections to the whole surface when the mold is viewed from above. At the time of the processing, the temperatures of the electrophotographic photosensitive member and the mold were controlled so that the temperature of the surface of the electrophotographic photosensitive member became 120° C., and while the electrophotographic photosensitive member and the pressurizing member were pressed against the mold at a pressure of 7.0 MPa, the electrophotographic photosensitive member was rotated in its circumferential direction to form depressed portions over the entire surface of the surface layer (circumferential surface) of the electrophotographic photosensitive member. Thus, an electrophotographic photosensitive member 1 was produced.

The surface of the resultant electrophotographic photosensitive member was subjected to magnified observation with a 50× lens under a laser microscope (product name: X-100, manufactured by Keyence Corporation), and the depressed portions formed on the surface of the electrophotographic photosensitive member were observed. At the time of the observation, adjustments were made so that: there was no inclination in the longitudinal direction of the electrophotographic photosensitive member; and the vertex of the circular arc of the electrophotographic photosensitive member in its circumferential direction was in focus. Images obtained by the magnified observation were connected to each other with an image connection application to obtain a square region measuring 500 m on each side. Then, for the obtained result, image-processed height data was selected and filter processing was performed with a filter type median through the use of image analysis software included with the microscope.

The results of the observation were as follows: the depressed portions had a depth of 2 μm, a width of an opening in the axial direction of 50 μm, a length of the opening in the circumferential direction of 75 μm, and an area of 140,000 μm². The area refers to the area of the depressed portions when the surface of the electrophotographic photosensitive member is viewed from above, and means the area of the openings of the depressed portions.

### Example 2

An electrophotographic photosensitive member of Example 2 was produced in the same manner as in Example 1 except that the compound represented by the formula (1) to be incorporated into the coating liquid for a surface layer was changed from Exemplified Compound (1-7) to Exemplified Compound (1-19).

### Example 3

An electrophotographic photosensitive member of Example 3 was produced in the same manner as in Example 1 except that the compound represented by the formula (1) to be incorporated into the coating liquid for a surface layer was changed from Exemplified Compound (1-7) to Exemplified Compound (1-11).

### Example 4

An electrophotographic photosensitive member of Example 4 was produced in the same manner as in Example 1 except that the compound represented by the formula (1) to be incorporated into the coating liquid for a surface layer was changed from Exemplified Compound (1-7) to Exemplified Compound (1-23).

### Example 5

An electrophotographic photosensitive member of Example 5 was produced in the same manner as in Example 1 except that the compound represented by the formula (1) to be incorporated into the coating liquid for a surface layer was changed from Exemplified Compound (1-7) to Exemplified Compound (1-3).

### Example 6

An electrophotographic photosensitive member of Example 6 was produced in the same manner as in Example 1 except that the compound represented by the formula (1) to be incorporated into the coating liquid for a surface layer was changed from Exemplified Compound (1-7) to Exemplified Compound (1-15).

### Example 7

An electrophotographic photosensitive member of Example 7 was produced in the same manner as in Example 1 except that the compound represented by the formula (2) to be incorporated into the coating liquid for a surface layer was changed from Exemplified Compound (2-3) to Exemplified Compound (2-4).

### Example 8

An electrophotographic photosensitive member of Example 8 was produced in the same manner as in Example 1 except that the compound represented by the formula (2) to be incorporated into the coating liquid for a surface layer was changed from Exemplified Compound (2-3) to Exemplified Compound (2-2).

### Example 9

An electrophotographic photosensitive member of Example 9 was produced in the same manner as in Example 1 except that the compound represented by the formula (2) to be incorporated into the coating liquid for a surface layer was changed from Exemplified Compound (2-3) to Exemplified Compound (2-5).

### Example 10

An electrophotographic photosensitive member of Example 10 was produced in the same manner as in Example 1 except that the compound represented by the formula (2) to be incorporated into the coating liquid for a surface layer was changed from Exemplified Compound (2-3) to Exemplified Compound (2-6).

### Example 11

An electrophotographic photosensitive member of Example 11 was produced in the same manner as in Example 1 except that the compound represented by the formula (2) to be incorporated into the coating liquid for a surface layer was changed from Exemplified Compound (2-3) to Exemplified Compound (2-1).

### Example 12

An electrophotographic photosensitive member of Example 12 was produced in the same manner as in Example 1 except that the siloxane-modified acrylic compound was not used in the coating liquid for a surface layer.

### Example 13

An electrophotographic photosensitive member of Example 13 was produced in the same manner as in Example 1 except that the compound represented by the formula (2) was not used in the coating liquid for a surface layer.

### Example 14

An electrophotographic photosensitive member of Example 14 was produced in the same manner as in Example 1 except that the compound represented by the formula (2) and the siloxane-modified acrylic compound were not used in the coating liquid for a surface layer.

### Example 15

An electrophotographic photosensitive member of Example 15 was produced in the same manner as in Example 14 except that the compound represented by the formula (1) to be incorporated into the coating liquid for a surface layer was changed from Exemplified Compound (1-7) to Exemplified Compound (1-11).

### Example 16

An electrophotographic photosensitive member of Example 16 was produced in the same manner as in Example 14 except that the compound represented by the formula (1) to be incorporated into the coating liquid for a surface layer was changed from Exemplified Compound (1-7) to Exemplified Compound (1-23).

### Example 17

An electrophotographic photosensitive member of Example 17 was produced in the same manner as in Example 14 except that the compound represented by the formula (1) to be incorporated into the coating liquid for a surface layer was changed from Exemplified Compound (1-7) to Exemplified Compound (1-3).

### Example 18

An electrophotographic photosensitive member of Example 18 was produced in the same manner as in Example 14 except that the compound represented by the formula (1) to be incorporated into the coating liquid for a surface layer was changed from Exemplified Compound (1-7) to Exemplified Compound (1-15).

### Example 19

An electrophotographic photosensitive member of Example 19 was produced in the same manner as in Example 14 except that the hole-transportable compound having a chain-polymerizable functional group to be incorporated into the coating liquid for a surface layer was changed from the compound represented by the formula (F) to a compound represented by the following formula (G).

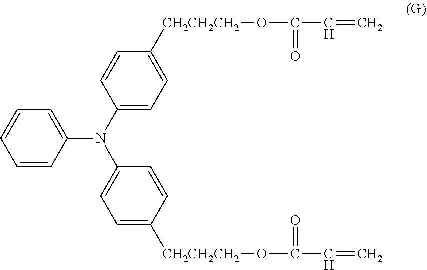

### Comparative Example 1

An electrophotographic photosensitive member of Comparative Example 1 was produced in the same manner as in Example 19 except that the compound represented by the formula (1) was not used in the coating liquid for a surface layer.

### Comparative Example 2

An electrophotographic photosensitive member of Comparative Example 2 was produced in the same manner as in Example 19 except that the compound represented by the formula (1) to be incorporated into the coating liquid for a surface layer was changed from Exemplified Compound (1-7) to a compound represented by the following formula (C-1).

### Comparative Example 3

An electrophotographic photosensitive member of Comparative Example 3 was produced in the same manner as in Example 19 except that the compound represented by the formula (1) to be incorporated into the coating liquid for a surface layer was changed from Exemplified Compound (1-7) to a compound represented by the following formula (C-2).

### Comparative Example 4

An electrophotographic photosensitive member of Comparative Example 4 was produced in the same manner as in Example 19 except that the compound represented by the formula (1) to be incorporated into the coating liquid for a surface layer was changed from Exemplified Compound (1-7) to a compound represented by the following formula (C-3).

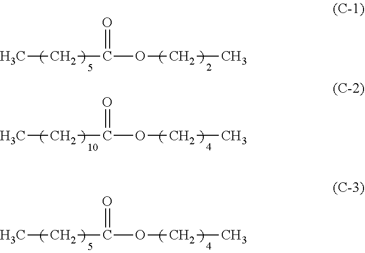

### Comparative Example 5

10 Parts of the compound represented by the formula (1) (Exemplified Compound (1-7)) was mixed in the coating liquid for a charge-transporting layer prepared in Example 1 to prepare a coating liquid for a surface layer. The coating liquid for a surface layer was applied onto a charge-transporting layer produced in the same manner as in Example 1 by dip coating to form a coat, and the resultant coat was dried for 30 minutes at 120° C. to form a surface layer (protective layer) having a thickness of 18 am. Depressed portions were formed over the entire surface of the resultant surface layer in the same manner as in Example 1. Thus, an electrophotographic photosensitive member of Comparative Example 5 was produced.

### Evaluations

The electrophotographic photosensitive member produced in each of Examples and Comparative Examples was mounted onto a cyan station of a reconstructed machine of an electrophotographic apparatus (copying machine) (product name: iR-ADV C5255, manufactured by Canon Inc.) serving as an evaluation apparatus, and subjected to image evaluation and electric characteristic evaluation in an environment at 30° C. and 80% RH under conditions described below.

<Image Streak Evaluation>

First, the total electric discharge current amount of a charging step was set to 70 μA, and a cassette heater (drum heater) in the apparatus was turned off. After that, image formation was continuously performed on 5,000 sheets using a test chart having an image percentage of 1%. Next, an image having 17 gray levels was formed at an output resolution of 600 dpi on A4 lateral size paper, and the resultant image on the entire surface of the A4 lateral size paper was evaluated as described below. In the present disclosure, Ranks A to C were each judged to indicate that an image streak-suppressing effect was sufficiently obtained, and Ranks D and E were each judged to indicate that the image streak-suppressing effect was not sufficiently obtained.

Rank A: No vertical streak is observed over the entire region of the image.

Rank B: Only one slight vertical streak is observed.

Rank C: Several slight vertical streaks occur in part of the image.

Rank D: Clear vertical streaks occur in part of the image.

Rank E: Clear vertical streaks occur on the entire surface of the image.

<Wear Resistance Evaluation>

Image formation was continuously performed on 100,000 sheets using a test chart having an image percentage of 1% under the same conditions as above, and the wear amount (μm) of the electrophotographic photosensitive member was confirmed. In the present disclosure, when the wear amount was less than 1.0 μm, it was judged that there was no problem with the wear resistance of the electrophotographic photosensitive member.

The evaluation results of the electrophotographic photosensitive members of Examples 1 to 19 and the electrophotographic photosensitive members of Comparative Examples 1 to 5 are shown in Table 3.

TABLE 3

| | Hole- | Com- | Com- | | |
|---|---|---|---|---|---|
| | transportable | pound | pound | | |
| | compound | repre- | repre- | | |
| | having chain- | sented by | sented by | Image | Wear |
| | polymerizable | formula | formula | streak | amount |
| | functional group | (1) | (2) | rank | (μm) |
| Example 1 | (F) | (1-7) | (2-3) | A | 0.42 |
| Example 2 | (F) | (1-19) | (2-3) | A | 0.44 |
| Example 3 | (F) | (1-11) | (2-3) | A | 0.56 |
| Example 4 | (F) | (1-23) | (2-3) | A | 0.54 |
| Example 5 | (F) | (1-3) | (2-3) | B | 0.38 |
| Example 6 | (F) | (1-15) | (2-3) | B | 0.40 |
| Example 7 | (F) | (1-7) | (2-4) | A | 0.44 |
| Example 8 | (F) | (1-7) | (2-2) | A | 0.42 |
| Example 9 | (F) | (1-7) | (2-5) | A | 0.56 |
| Example 10 | (F) | (1-7) | (2-6) | A | 0.62 |
| Example 11 | (F) | (1-7) | (2-1) | A | 0.58 |
| Example 12 | (F) | (1-7) | (2-3) | B | 0.46 |
| Example 13 | (F) | (1-7) | — | A | 0.78 |
| Example 14 | (F) | (1-7) | — | B | 0.82 |
| Example 15 | (F) | (1-11) | — | B | 0.88 |
| Example 16 | (F) | (1-23) | — | B | 0.92 |
| Example 17 | (F) | (1-3) | — | C | 0.78 |
| Example 18 | (F) | (1-15) | — | C | 0.80 |
| Example 19 | (G) | (1-7) | — | B | 0.86 |
| Comparative | (G) | — | — | D | 0.76 |
| Example 1 | | | | | |
| Comparative | (G) | (C-1) | — | D | 0.82 |
| Example 2 | | | | | |
| Comparative | (G) | (C-2) | — | B | 1.22 |
| Example 3 | | | | | |
| Comparative | (G) | (C-3) | — | D | 1.16 |
| Example 4 | | | | | |
| Comparative | — | (1-7) | — | B | Circumfer- |
| Example 5 | | | | | ential flaw |
| | | | | | occurred |

The results of the evaluations revealed that, in each of Examples, the image streak-suppressing effect was sufficiently obtained, and there was no problem with the wear resistance.

In each of Comparative Examples 1 and 2, the image streak-suppressing effect was not sufficiently obtained. In Comparative Example 3, there was a problem with the wear resistance. In Comparative Example 4, the image streak-suppressing effect was not sufficiently obtained, and there was a problem with the wear resistance. In Comparative Example 5, a circumferential flaw occurred on the surface of the electrophotographic photosensitive member during the passing of 100,000 sheets. Accordingly, the wear resistance evaluation was stopped, and it was judged that there was a problem with the wear resistance.

According to one aspect of the present disclosure, the electrophotographic photosensitive member that can achieve both of satisfactory wear resistance and the suppression of an image streak at the time of its repeated use, and the production method for the electrophotographic photosensitive member can be provided. According to one aspect of the present disclosure, the process cartridge and the electrophotographic apparatus each including the electrophotographic photosensitive member can also be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-215814, filed Nov. 16, 2018, which is hereby incorporated by reference herein in its entirety.

What is claimed is:

1. An electrophotographic photosensitive member comprising:
a support; and
a photosensitive layer,
wherein a surface layer of the electrophotographic photosensitive member contains: a polymer of a hole-transportable compound having a chain-polymerizable functional group; and a compound represented by the following formula (1): 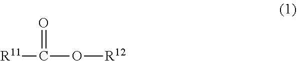
in the formula (1), one of R¹¹ and R¹² represents a linear alkyl group having 7 or more carbon atoms, and another thereof represents a linear alkyl group having 1 or more and 4 or less carbon atoms.

2. The electrophotographic photosensitive member according to claim 1, wherein in the formula (1), the one of R¹¹ and R¹² represents a linear alkyl group having 7 or more and 18 or less carbon atoms, and the other thereof represents a linear alkyl group having 1 or more and 4 or less carbon atoms.

3. The electrophotographic photosensitive member according to claim 1, wherein in the formula (1), the one of R¹¹ and R¹² represents an undecyl group, and the other thereof represents a n-propyl group.

4. The electrophotographic photosensitive member according to claim 1, wherein in the formula (1), R¹¹ represents a linear alkyl group having 7 or more carbon atoms, and R¹² represents a linear alkyl group having 1 or more and 4 or less carbon atoms.

5. The electrophotographic photosensitive member according to claim 1, wherein the surface layer contains a copolymer of the hole-transportable compound having a chain-polymerizable functional group and a compound represented by the following formula (2): 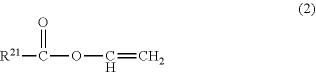
in the formula (2), R²¹ represents a linear alkyl group having 7 or more carbon atoms.

6. The electrophotographic photosensitive member according to claim 5, wherein in the formula (2), R²¹ represents a linear alkyl group having 9 or more and 13 or less carbon atoms.

7. The electrophotographic photosensitive member according to claim 1, wherein the surface layer contains a siloxane-modified (meth)acrylic compound.

8. The electrophotographic photosensitive member according to claim 1, wherein the hole-transportable compound comprises a compound represented by the following formula (3): 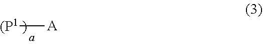
in the formula (3), A represents a hole-transportable group, P¹ represents an acryloyloxy group or a methacryloyloxy group, “a” represents an integer of from 2 to 4, and P¹s may be identical to or different from each other, and a hydrogen adduct obtained by replacing a bonding site of the A to P¹ with a hydrogen atom is represented by the following formula (4) or the following formula (5): 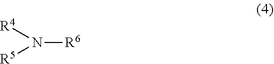
in the formula (4), R⁴, R⁵, and R⁶ each represent a phenyl group that may have an alkyl group having 1 to 6 carbon atoms as a substituent, and R⁴, R⁵, and R⁶ may be identical to or different from each other; 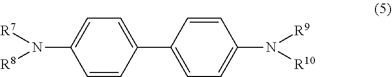
in the formula (5), R⁷, R⁸, R⁹, and R¹⁰ each represent a phenyl group that may have an alkyl group having 1 to 6 carbon atoms as a substituent, and R⁷, R⁸, R⁹, and R¹⁰ may be identical to or different from each other.

9. A production method for an electrophotographic photosensitive member including a support and a photosensitive layer, the production method comprising:
preparing a coating liquid for a surface layer containing a composition containing a hole-transportable compound having a chain-polymerizable functional group and a compound represented by the following formula (1);
forming a coat of the coating liquid for a surface layer; and
curing the coat to form a surface layer: 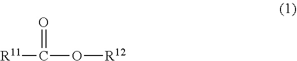
in the formula (1), one of R¹¹ and R¹² represents a linear alkyl group having 7 or more carbon atoms, and another thereof represents a linear alkyl group having 1 or more and 4 or less carbon atoms.

10. A process cartridge comprising:
an electrophotographic photosensitive member; and
at least one unit selected from the group consisting of a charging unit, a developing unit, and a cleaning unit,
the process cartridge integrally supporting the electrophotographic photosensitive member and the at least one unit, and being removably mounted onto a main body of an electrophotographic apparatus,
wherein the electrophotographic photosensitive member comprises an electrophotographic photosensitive member including a support and a photosensitive layer, the electrophotographic photosensitive member including a surface layer containing: a polymer of a hole-transportable compound having a chain-polymerizable functional group; and a compound represented by the following formula (1): 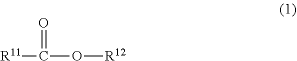
in the formula (1), one of R¹¹ and R¹² represents a linear alkyl group having 7 or more carbon atoms, and another thereof represents a linear alkyl group having 1 or more and 4 or less carbon atoms.

11. An electrophotographic image-forming apparatus comprising:
an electrophotographic photosensitive member; and
at least one unit selected from the group consisting of a charging unit, an exposing unit, a developing unit, and a transferring unit,
wherein the electrophotographic photosensitive member comprises an electrophotographic photosensitive member including a support and a photosensitive layer, the electrophotographic photosensitive member including a surface layer containing: a polymer of a hole-transportable compound having a chain-polymerizable functional group; and a compound represented by the following formula (1): 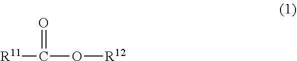
in the formula (1), one of R¹¹ and R¹² represents a linear alkyl group having 7 or more carbon atoms, and another thereof represents a linear alkyl group having 1 or more and 4 or less carbon atoms.
